(19) United States
(12) Patent Application Publication
(10) Pub. No.: US 2025/0183759 A1
(43) Pub. Date: Jun. 5, 2025

(54) COMMON OIL DISTRIBUTOR

(71) Applicant: Dana Automotive Systems Group, LLC, Maumee, OH (US)

(72) Inventors: Cody OTT, Ida, MI (US); Gowrisankar DEVARAJ, Leamington Spa (GB); Gaetan MARCEAU, Brossard (CA)

(21) Appl. No.: 18/530,016

(22) Filed: Dec. 5, 2023

(51) Int. Cl. H02K 9/19; F16N 25/00

(52) U.S. Cl. CPC H02K 9/19; F16N 25/00; F16N 2210/18

(57) ABSTRACT

Systems are provided herein for an oil distribution system of an electric drive unit comprising a back-to-back twin motor configuration. In one example, an oil distributor comprises a first distribution channel comprising a first inlet section and a first outlet section; and a second distribution channel comprising a second inlet section and a second outlet section, wherein the first and second inlet sections are included in a main body and the first and second outlet sections protrude radially away from the main body in opposite directions; and the first distribution channel distributes oil to a first rotor shaft coupled to a first electric motor and the second distribution channel distributes oil to a second rotor shaft coupled to a second electric motor.

### TECHNICAL FIELD

The present disclosure relates generally to cooling and lubrication systems for an electric drive unit in an electric vehicle.

### BACKGROUND AND SUMMARY

Electric drive units include moving components such as bearings, gears, etc. and other components, such as clutches, that generate friction and heat during operation. To lubricate and cool these components, cooling and lubrication assemblies have been integrated within the electric drive units to direct oil to these components. For example, in some systems, an oil circuit is used to direct oil to transmission components, and a separate coolant circuit is used to remove heat from the electric motor components.

In some electric vehicle systems, two electric motors are included. Packaging size of an electric drive unit with two motors can be reduced with a back-to-back twin motor configuration. However, such a configuration may result in ineffective transfer of oil to rotor shafts of the motors, thereby reducing efficiency of cooling and lubrication of the rotor shafts. Consequently, oiling may need to be individually conditioned for each motor, for example with separate oil distributors for each motor. However, having more than one oil distributors may result in larger packaging demands.

The inventors herein have recognized these issues and developed a common oil distributor for an electric drive unit with back-to-back electric motors that at least partially addresses these issues. The common oil distributor herein described includes a first distribution channel and a second distribution channel aligned along a single plane. The first distribution channel may distribute oil to a first rotor shaft coupled to or otherwise of a first electric motor and the second distribution channel may distribute oil to a second rotor shaft coupled to or otherwise of a second electric motor.

In one example, an oil distributor is configured to distribute oil to a first electric motor and a second electric motor. The oil distributor is a common oil distributor that comprises a main body, a first distribution channel, and a second distribution channel. The main body comprises a first outer rim and a second outer rim, each comprising an o-ring seal. The first distribution channel comprises a first inlet and a first outlet and the second distribution channel comprises a second inlet and a second outlet. The first distribution channel may further comprise a first inlet channel and a first outlet channel and the second distribution channel may further comprise a second inlet channel and a second outlet channel. Each of the first and second inlet channels may be in fluid communication with a respective inlet and a respective outlet channel. Each of the first and second outlet channels may be in fluid communication with a respective outlet and a respective inlet channel. Each inlet channel may connect to a respective outlet channel at a bend so as to allow inflow of oil in a first direction and outflow of oil in a second direction.

In some examples, the first and second outlets are position coaxial with each other and with a shared axis of rotation of a first rotor shaft of the first electric motor and a second rotor shaft of the second electric motor. The first and second inlets may be coaxial and the first and second inlet channels may be arranged parallel to each other and configured at a specified angle with respect to respective outlet channels. In this way, the inlet channels may be formed as part of the main body of the oil distributor in order to reduce space between the first and second electric machines.

In operation, oil may be conditioned for the first motor and the second motor independently. Oil conditioned for the first motor may flow into the first inlet and oil conditioned for the second motor may flow into the second inlet. The first and second inlets may be in fluid communication with a first and second groove, respectively, of the main body. The first and second grooves may be formed between the first and second outer rims of the main body. The first and second grooves may form first and second channels when the oil distributor is positioned within a housing, the o-ring seals acting as a seal with the housing. The main body may comprise a divider such that oil that flows into the first channel does not flow into the second channel and oil that flows into the second channel does not flow into the first channel. In this way, oil flowing into the oil distributor may remain separate in order to allow independently conditioned oil to be distributed to a respective motor.

The common oil distributor as herein described may reduce a distance between the first and second electric motors when in a back-to-back formation. As the main body includes both inlet channels, a single distributor assembly may be used to distribute oil to both motors rather than demanding separate oil distributor assemblies for each motor. Additionally, the common oil distributor when positioned within the housing may reliably maintain separation between independently conditioned oil.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows a schematic of an exemplary vehicle.

FIG. 2 shows a diagram of a first example of a portion of an electric drive unit (EDU) with back-to-back electric motors.

FIG. 3 shows a perspective view of a common oil distributor.

FIG. 4 shows a portion of an EDU including the common oil distributor of FIG. 3.

FIG. 5 shows a lateral view of the EDU of FIG. 4.

FIG. 6 shows a detailed view of the EDU of FIG. 4.

FIG. 7 shows a diagram of a second example of a portion of an EDU with back-to-back electric motors.

### DETAILED DESCRIPTION

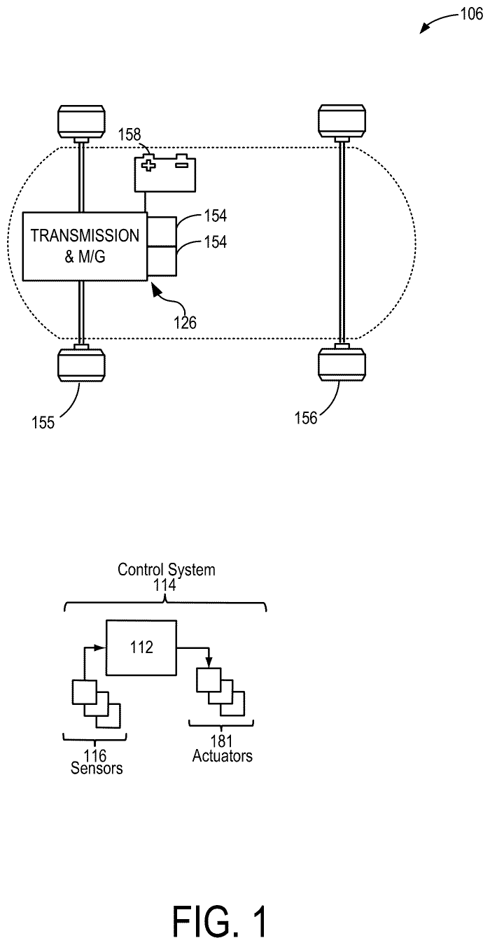

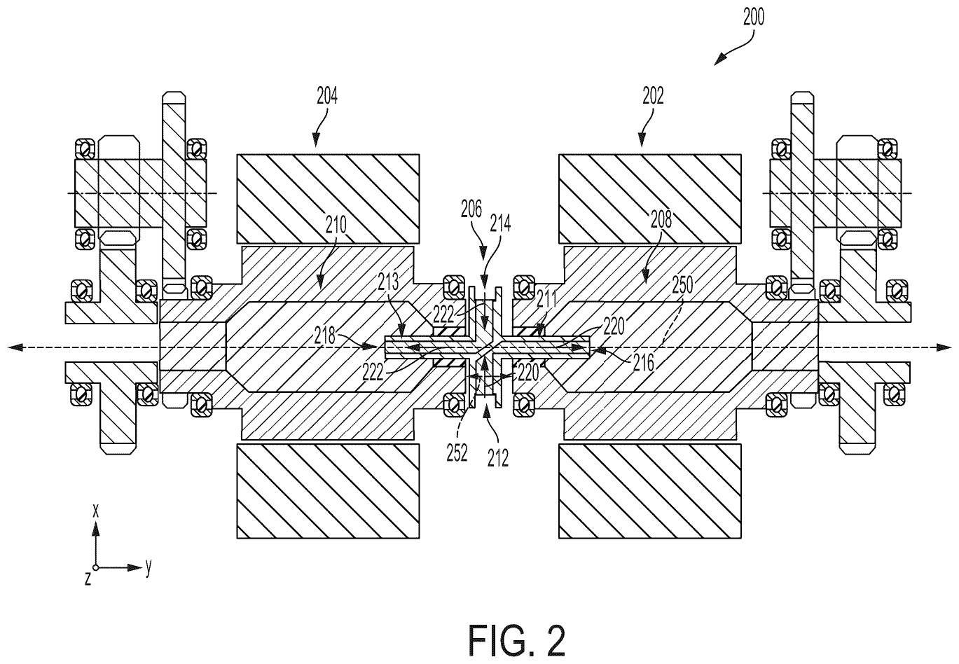

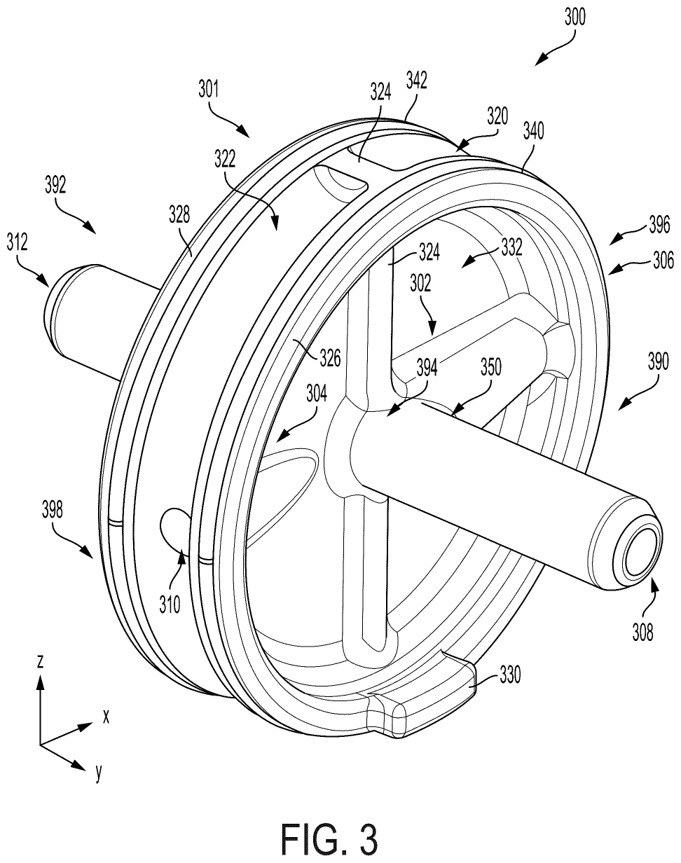

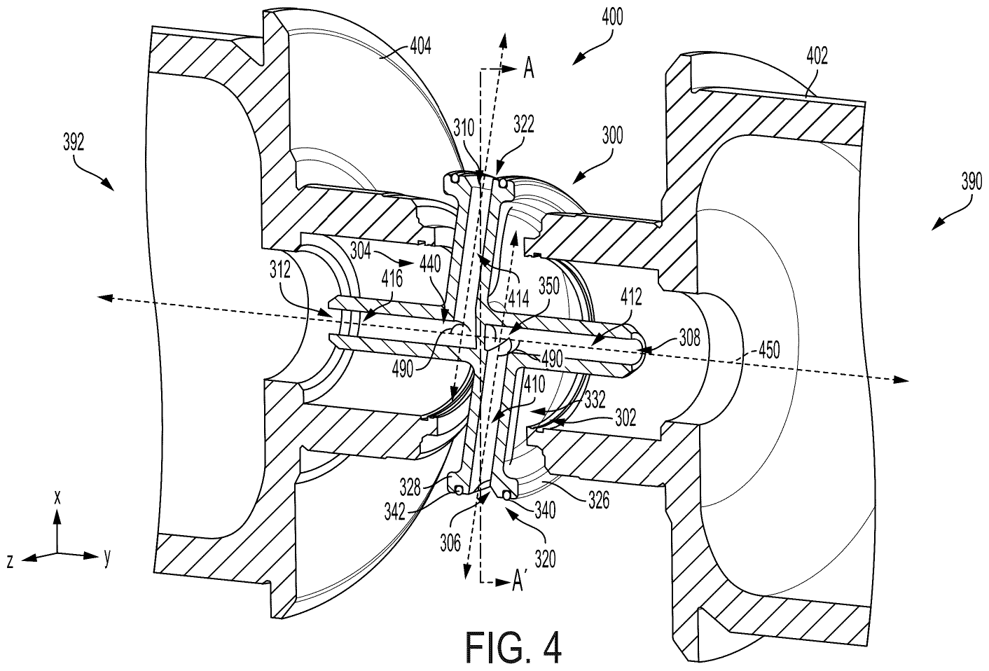

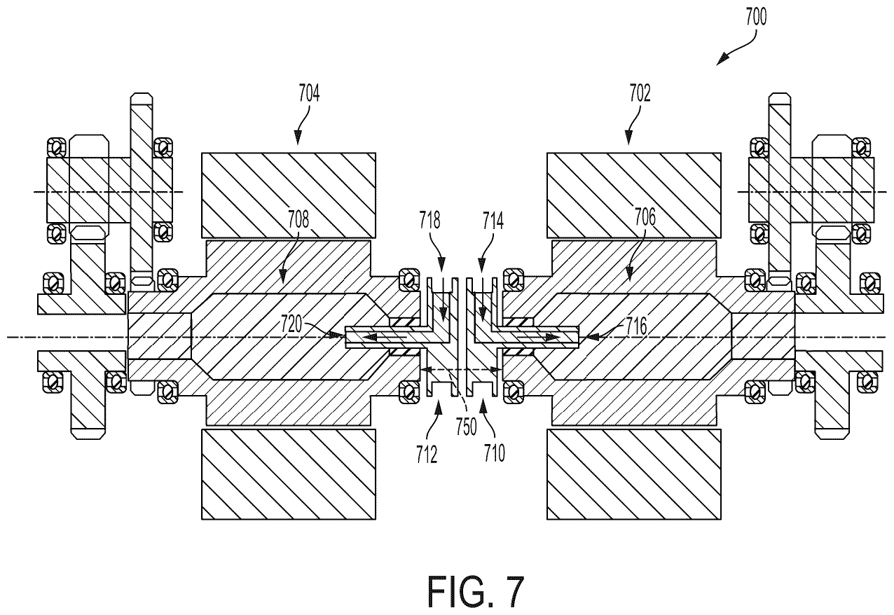

An oil distribution system comprising a common oil distributor for an electric drive unit (EDU) with a back-to-back twin electric motor configuration is described herein. In some examples, the oil distribution system may reduce a distance between the two electric motors by configuring distribution channels to rotor shafts of each of the motors along a single plane. The common oil distributor, configured as a circular shape, may comprise a first oil distribution channel to provide oil to a first rotor shaft coupled to or otherwise of a first electric motor and a second oil distribution channel to provide oil to a second rotor shaft of a second electric motor. Each oil distribution channel comprises an inlet, an inlet channel, an outlet channel, and an outlet. The outlet channels and outlets of the first and second oil distribution channels may be arranged coaxial with each other and with a shared axis of rotation of the first and second rotor shafts, which are also arranged coaxial to each other in the back-to-back configuration. The common oil distributor, as will be herein described, may allow oil conditioned for the first electric motor to enter into the common oil distributor and be distributed to the first motor at the same time as oil conditioned for the second electric motor enters into the common oil distributor and is distributed to the second electric motor. FIG. 1 shows an exemplary vehicle system in which a common oil distributor may be used. A diagram of a portion of a first example EDU including a common oil distributor is shown in FIG. 2. An exemplary common oil distributor is shown in FIG. 3 and a portion an exemplary EDU in which the common oil distributor of FIG. 3 is shown in FIGS. 4-6. FIG. 7 shows a diagram of a portion of a second example EDU including two separate oil distributors.

FIGS. 1-7 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

FIGS. 2-7 are drawn approximately to scale. However, other relative component dimensions may be used, in other embodiments.

FIG. 1 is a schematic drawing that depicts an electric vehicle 106 with an electric drive unit that generates motive power for vehicle propulsion. The electric vehicle 106 may be a light, medium, or heavy duty vehicle. Specifically, in one use-case example, the electric vehicle 106 may be a passenger vehicle such as a truck, sedan, wagon, and the like. However, in other examples, the electric vehicle 106 may be an off-highway vehicle or other type of vehicle. Further, the electric vehicle 106 may be a battery electric vehicle (BEV), a series hybrid electric vehicle (HEV) that includes an internal combustion engine, or a fuel-cell electric vehicle, as non-limiting examples.

In one embodiment, the electric vehicle 106 may include an EDU 126. The EDU 126 comprises one or more electric motors 154. In some examples, the EDU 126 may comprise two electric motors 154 in a back-to-back configuration whereby the electric motors 154 are aligned coaxially and oriented facing away from each other. Electric motors 154 may be traction motors. Electric motors 154 may receive electrical power from a traction battery 158 to provide torque to rear vehicle wheels 155. Electric motors 154 may also be operated as a generator to provide electrical power to charge traction battery 158, for example during a braking operation. Additionally, it should be appreciated that while FIG. 1 depicts the EDU 126 and electric motors 154 mounted in a rear wheel drive configuration with drive shafts towards the rear axles, other configurations are possible, such as employing electric motors 154 in an central axle configuration, a front axle configuration, or in a configuration in which there is one or EDUs included therein, for example one EDU in a rear wheel drive configuration and a second EDU in a front wheel drive configuration.

Electric motors 154 may be coupled to an outside of a transmission/gearbox housing. The transmission/gearbox housing may house a transmission system. The transmission system may include one or more shafts, gears, and clutches to transfer mechanical power generated by the electric motors 154 downstream. A controller 112 may send a signal to actuator(s) of the clutches to shift respective positions of the clutches, so as to shift gears for power transmission from the electric motors 154 to the rear vehicle wheels 155 and/or the front vehicle wheels 156.

Controller 112 may form a portion of a control system 114. Controller 112 may include a microcomputer with components such as a processor (e.g., a microprocessor unit), input/output ports, an electronic storage medium for executable programs and calibration values (e.g., a read-only memory chip, random access memory, keep alive memory, a data bus, and the like). The storage medium may be programmed with computer readable data representing instructions executable by a processor for performing the methods and control techniques described herein as well as other variants that are anticipated but not specifically listed. Control system 114 is shown receiving information from a plurality of sensors 116 and sending control signals to a plurality of actuators 181. For example, the sensors 116 may include a pedal position sensor designed to detect a depression of an operator-actuated pedal such as an accelerator pedal and/or brake pedal, a speed sensor at the transmission output shaft, energy storage device state of charge (SOC) sensor, clutch position sensors, and the like. Motor speed may be ascertained from the amount of power sent from an inverter to an electric machine. An input device (e.g., accelerator pedal, brake pedal, drive mode selector, combinations thereof, and the like) may further provide input signals indicative of an operator's intent for vehicle control. As another example, the actuators may include the clutch, etc.

Upon receiving the signals from the various sensors 116 of FIG. 1, the controller 112 processes the received signals and employs various actuators 181 of vehicle components to adjust the components based on the received signals and instructions stored in the memory of controller 112. For example, the controller 112 may receive an accelerator pedal signal indicative of an operator's request for increased vehicle acceleration. In response, the controller 112 may command operation of inverters to adjust electric machine power output and increase power delivered from the electric machine(s) to the transmission. The controller 112 may, during certain operating conditions, be designed to send commands to clutches to engage and disengage clutch gears. For instance, a control command may sent to a clutch and in response to receiving the command, an actuator in the clutch may adjust the clutch based on the command for clutch engagement or disengagement. The other controllable components in the vehicle may function in a similar manner with regard to sensor signals, control commands, and actuator adjustment, for example.

Turning now to FIG. 2, a diagram of a portion of an example EDU 200 is shown. The EDU 200 comprises a first electric motor 202 and a second electric motor 204. The first and second electric motors 202, 204 may be arranged coaxially, for example along shared axis of rotation 250. The first electric motor 202 may comprise or otherwise be coupled to a first rotor shaft 208 and the second electric motor 204 may comprise or otherwise be coupled to a second rotor shaft 210. The first and second rotor shafts 208, 210 may also be arranged coaxially and may both rotate about the shared axis of rotation 250.

The EDU 200 may further comprise an oil distributor 206. The oil distributor 206 may be a common oil distributor as is herein disclosed that is configured to distribute oil to both the first and second rotor shafts 208, 210. The oil distributor 206 may comprise a first distribution channel 211 and a second distribution channel 213. The first distribution channel 211 may be configured to distribute oil to the first rotor shaft 208 and the second distribution channel 213 may be configured to distribute oil to the second rotor shaft 210. As will be further described with respect to FIG. 3, each of the first and second distribution channels 211, 213 may be configured with a bend to direct oil from an inlet in one axis to an outlet in a different axis.

The first distribution channel 211 may comprise a first inlet 212 and a first outlet 216 and the second distribution channel 213 may comprise a second inlet 214 and a second outlet 218. The first and second inlets 212, 214 may be aligned along a first axis and the first and second outlets 216, 218 may be aligned along a second axis that is perpendicular to the first axis. The second axis may be parallel and/or coaxial with the shared axis of rotation 250. The first and second inlets 212, 214 may be arranged opposite one another such that oil enters into the first inlet 212 in a first direction and oil enters into the second inlet 214 in a second direction that is directly opposite the first direction. Similarly, the first and second outlets 216, 218 may be arranged opposite one another such that oil exits the first outlet 216 in a third direction and oil exits the second outlet 218 in a fourth direction that is directly opposite the third direction. For example, arrows 220 demonstrate directions of flow through the first distribution channel 211 and arrows 222 demonstrate directions of flow through the second distribution channel 213.

The oil distributor 206 is configured between the first and second electric motors 202, 204. A distance 252 between the first and second electric motors 202, 204 may be dependent upon a width of the oil distributor 206. The distance 252 may be smaller than with two separate oil distributors arranged between the first and second motors. Turning briefly to FIG. 7, a diagram of a portion of an EDU 700 is shown. The EDU 700, similar to the EDU 200, may comprise two electric motors in a back-to-back twin motor configuration whereby the two motors are arranged coaxially and facing away from each other. Rotor shafts thereof may therefore have coaxial axes of rotation.

However, the EDU 700, in contrast to the EDU 200 of FIG. 2, includes two separate oil distributors, one for each motor. For example, the EDU 700 comprises a first oil distributor 710 and a second oil distributor 710 both positioned between a first electric motor 702 and a second electric motor 704 and each comprising a distribution channel. The first oil distributor 710 may be configured to distribute oil to a first rotor shaft 706 of the first electric motor 702, whereby oil enters a first inlet 714 and exits a first outlet 716. The second oil distributor 712 may be configured to distribute oil to a second rotor shaft 708 of the second electric motor 704, whereby oil enters a second inlet 718 and exits a second outlet 720. The first and second oil distributors 710, 712 may be arranged directly adjacent to one another such that the first inlet 714 and second inlet 718 are parallel to each other and oil flows into both the first inlet 714 and second inlet 718 in the same direction.

Because the first and second oil distributors 710, 712 are positioned directly adjacent to one another and the inlets thereof are parallel to each other, a distance 750 between the first electric motor 702 and the second electric motor 704 may be greater than the distance 252 of the EDU 200 of FIG. 2. In this way, packaging space demands may be reduced with the common oil distributor herein disclosed.

Referring now to FIG. 3, a detailed perspective view of a common oil distributor 300 is shown. The common oil distributor 300 may be an example of the oil distributor 206 described with respect to FIG. 2. The common oil distributor 300 may be included within an EDU, as will be described with respect to FIGS. 4-6. An axis system is provided in FIG. 3, as well as FIGS. 4-6, for reference. An x-axis may be a lateral axis, a z-axis may be a vertical (e.g., gravitational) axis, and a y-axis may be a longitudinal axis, in some examples. In other examples, other axes may be used. The common oil distributor 300 may be arranged with in a vehicle according to the axis system, in some examples.

The common oil distributor 300 may comprise a main body 301 with a central face 332. The main body 301 and the central face 332 may be configured as a circular shape, in some examples. As is described with respect to FIG. 2, the common oil distributor 300 may comprise a first distribution channel 302 and a second distribution channel 304. The first distribution channel 302 may comprise a first inlet 306 and a first outlet 308. The second distribution channel 304 may comprise a second inlet 310 and a second outlet 312. The first and second distribution channels may be formed of an inlet channel and an outlet channel, as will be described with respect to FIG. 4. The first and second inlets 306, 310 may be a part of the main body 301. Each of the first and second distribution channels 302, 304 may comprise a bend near a center 394 of the main body 301. For example, the first distribution channel 302 may comprise a first bend 350 near the center 394 of the main body 301.

The first and second inlets 306, 310 may be positioned coaxial with one another parallel with the x-axis. The first and second inlets 306, 310 may be positioned opposite each other, e.g., at opposite ends of the main body 301. For example, the first inlet 306 may be positioned at a first end 396 and the second inlet 310 may be positioned at a second end 398 opposite the first end 396. Similarly, the first and second outlets 308, 312 may be positioned coaxial with one another parallel with the y-axis. The first and second outlets 308, 312 may be positioned opposite each other, e.g., at opposite sides of the main body 301 and may protrude radially away from the main body 301 in opposite directions. For example, the first outlet 308 may be positioned at a first side 390 and the second outlet 312 may be positioned at a second side 392 opposite the first side 390.

The main body 301 of the common oil distributor 300 may further comprise a first outer rim 326 and a second outer rim 328. The first outer rim 326 may be positioned towards the first side 390 and the second outer rim 328 may be positioned towards the second side 392. The central face 332 may be positioned at a midpoint between the first outer rim 326 and the second outer rim 328. The first and second outer rims 326, 328 may be circumferential about the main body 301. The first and second outer rims 326, 328 may define therebetween a first groove 320 and a second groove 322. The first and second grooves 320, 322 may be separated by a dividing wall 324. The first inlet 306 may be in fluid communication with the first groove 320 and the second inlet 310 may be in fluid communication with the second groove 322. As will be demonstrated with respect to FIGS. 4-6, oil that enters the common oil distributor 300 may be directed into one of the first and second grooves 320, 322. Oil that is directed into the first groove 320 may enter the first inlet 306 and oil that is directed into the second groove 322 may enter the second inlet 310.

The first outer rim 326 may further comprise a first o-ring seal 340 and the second outer rim 328 may comprise a second o-ring seal 342, both of which are circumferential about the respective rims. The first and second o-ring seals 340, 342 may be configured to contact a housing such that the first and second grooves 320, 322 are sealed off from the housing, forming channels for oil to flow within. The main body 301 may further comprise an alignment feature 330. The alignment feature 330 may allow the common oil distributor 300 to be positioned within an EDU in a correct orientation.

Turning now to FIG. 4, a cross-sectional view of a portion of an EDU 400 that includes two electric motors in a back-to-back configuration is shown. The EDU 400 may comprise the common oil distributor 300 of FIG. 3. The common oil distributor 300 may be positioned between the electric motors. Specifically, the common oil distributor 300 may be positioned between a first rotor shaft 402 and a second rotor shaft 404 so as to distribute oil to both the first rotor shaft 402 and the second rotor shaft 404. As described with respect to FIG. 2, the first and second rotor shafts 402, 404 may be positioned coaxially so as to share an axis of rotation 450. The axis of rotation 450 may be parallel with the y-axis, in some examples.

The common oil distributor 300 may be positioned within the EDU 400 such that the first and second outlets 308, 312 are aligned with the axis of rotation 450 and the first outer rim 326 is positioned towards the first rotor shaft 402 and the second outer rim 328 is positioned towards the second rotor shaft 404. The cross-sectional view of the EDU 400 demonstrates a cross-section of the common oil distributor 300. The first distribution channel 302 may comprise a first inlet section 410 and a first outlet section 412. Similarly, the second distribution channel 304 may comprise a second inlet section 414 and a second outlet section 416.

In the first distribution channel 302, the first inlet 306 may be in fluid communication with the first inlet section 410 such that oil that flows into the first inlet 306 flows into the first inlet section 410. Between the first inlet section 410 and the first outlet section 412 may be the first bend 350, as such the first inlet section 410 and the outlet section 412 may be in fluid communication at the first bend 350. The first outlet section 412 may be in further fluid communication with the first outlet 308. Similarly, in the second distribution channel 304, the second inlet 310 may be in fluid communication with the second inlet section 414. Between the second inlet section 414 and the second outlet section 416 may be a second bend 440. The second outlet section 416 may be in fluid communication with second outlet 312.

During operation, oil that enters into the first groove 320 may flow into the first inlet 306, into the first inlet section 410 of the first distribution channel 302, from the first inlet section 410 into the first outlet section 412, from the first outlet section 412 to the first outlet 308, and from the first outlet 308 to the first rotor shaft 402. Similarly, oil that enters into the second groove 322 may flow into the second inlet 310, into the second inlet section 414 of the second distribution channel 304, from the second inlet section 414 to the second outlet section 416, from the second outlet section 416 to the second outlet 312, and from the second outlet 312 to the second rotor shaft 404. In this way, the common oil distributor maintains separation of independently conditioned oil such that oil entering into the first groove does not flow into the second groove, and vice versa. Therefore, the common oil distributor may reduce packaging space while maintaining adequate distribution of conditioned oil to respective motors.

It should be appreciated that the oil provided for distribution as described herein is part of an overall oil circuit where oil is collected in a sump, pressurized, and then delivered to the system at an operating pressure to enable the distribution of the oil. The maintenance of oil in different grooves is thus in respect to the flow of oil in the particular grooves, recognizing that the oils may eventually mix in a collection region, such as in the sump.

The first and second outlet sections 412 and 416 may be coaxial along the axis of rotation 450. The first and second inlet sections 410 and 414 may be parallel with one another and oriented at an angle 490 relative to the axis of rotation 450. The inlet sections 410 and 414 being aligned parallel to each other at the angle 490 may allow for the first and second bends 350 and 440 to be positioned along the same axis adjacent to each other without increasing the distance between the first and second rotor shafts 402, 404.

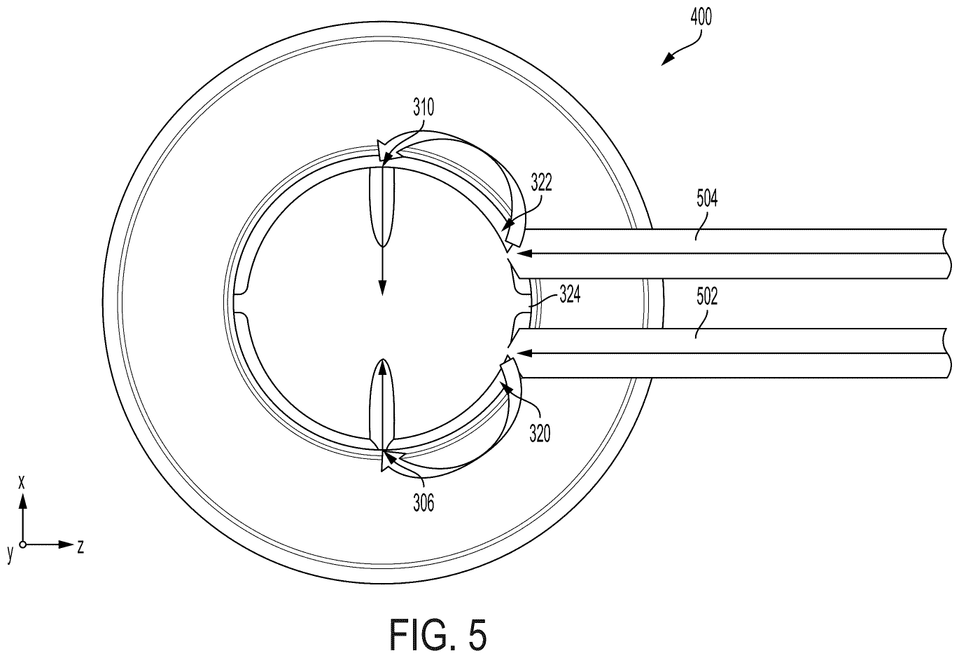

Turning to FIG. 5, a cross-sectional lateral view of the EDU 400 is shown. In FIG. 5, the EDU 400 is cross sectioned across cutting plane A-A′ of FIG. 4. As such, portions of the first inlet 306 and the inlet section 410 of the first distribution channel 302 and the second inlet 310 and the inlet section 414 of the second distribution channel 304 are depicted. Additionally, the first groove 320 and the second groove 322 are depicted.

In some examples, the EDU 400 may be coupled to one or more oil inlets. For example, the EDU 400 may couple to a first oil inlet 502 and a second oil inlet 504. The first and second oil inlets 502, 504 may provide oil to the EDU 400. Oil from the first oil inlet 502 may flow into the first groove 320 and oil from the second oil inlet 504 may flow into the second groove 322. As the first groove 320 is in fluid communication with the first inlet 306, oil from the first oil inlet 502 may flow into the first distribution channel 302. Similarly, as the second groove 322 is in fluid communication with the second inlet 310, oil from the second oil inlet 504 may flow into the second distribution channel 304. Oil from one of the inlets may not cross over to a non-corresponding groove due to the dividing wall which separates the first groove 320 from the second groove 322. In this way, the separately conditioned oil may remain separate in the common oil distributor 300.

In some examples, the first and second oil inlets 502, 504 may be positioned parallel to each other and may be positioned radial to the common oil distributor 300. The first and second oil inlets 502, 504 may be adjacent to each other, which may simplify manufacture of and manufacture set up for the housing. Further, arranging the first and second oil inlets 502 adjacent and parallel to each other and radial to the common oil distributor 300 may allow for mounting of heat exchangers in the same region as the common oil distributor 300, thereby simplifying assembly of the EDU.

In some examples, oil in the first oil inlet 502 may be conditioned for the first rotor shaft to which the first distribution channel 302 provides oil. Similarly, oil in second oil inlet 504 may be conditioned for the second rotor shaft to which the second distribution channel 304 provides oil. In this way, oil provided to both the rotor shafts may be conditioned and supplied individually via the common oil distributor 300. Conditioning oil independently may account for deltas in motor load (e.g., heat and friction) between the two electric motors. The common oil distributor 300 may allow independently conditioned oil to be provided to separate electric motors without increasing packaging space between the motors when arranged in a back-to-back configuration.

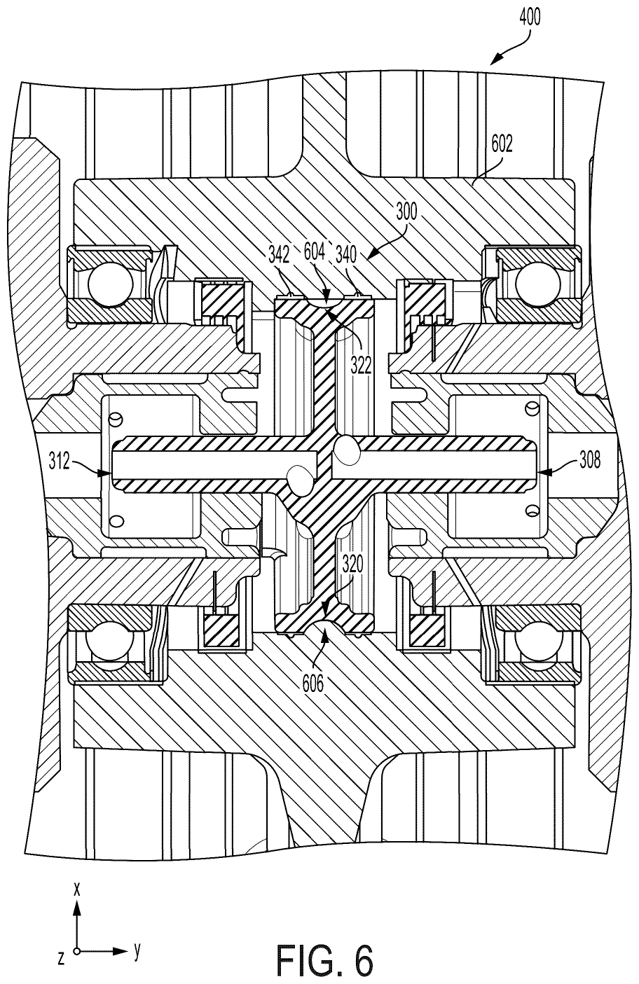

Turning now to FIG. 6, another cross-sectional view of the EDU 400 is shown. The EDU 400 and the common oil distributor 300 thereof may be arranged within a housing 602. When the common oil distributor 300 is positioned within the housing 602, the first o-ring seal 340 and the second o-ring seal 342 may be in face sharing contact with the housing 602 such as to create a water tight seal. When the first and second o-ring seals 340, 342 are in contact with the housing 602, a first channel 604 may be formed between the first groove 320 and the housing and a second channel 606 may be formed between the second groove 322 and the housing. The first channel 604, like the first groove 320, may be in fluid communication with the first inlet 306 and the second channel 606, like the second groove 322, may be in fluid communication with the second inlet 310.

Because of the seal created by the o-ring seals, oil that enters the common oil distributor 300, for example via oil inlets like the first and second oil inlet 502 and 504, may remain within a given channel and enter a corresponding distribution channel. In this way, the first and second distribution channels 302, 304 may be fluidically isolated from one another when the common oil distributor 300 is positioned within the housing. As noted above the fluidic isolation here is with respect to the common oil distributor 300, for example, not in the context of the overall oil circuit.

A technical effect of the systems provided herein is that a distance between first and second electric motors arranged in a back-to-back configuration may be reduced. By including inlet sections of distribution channels for the first and second electric motors within a main body of a single common oil distributor, the need for separate oil distributors for each of the motors is mitigated. Further, fluidically isolating the distribution channels from each other, via the dividing wall that separates the two grooves of the main body, may maintain separation between independently conditioned oils such that oil conditioned for the first motor may be distributed to the first motor without being affected by oil conditioned for the second motor, and vice versa.

The disclosure also provides support for an oil distributor, comprising: a first distribution channel comprising a first inlet section and a first outlet section, and a second distribution channel comprising a second inlet section and a second outlet section, wherein: the first and second inlet sections are included in a main body and the first and second outlet sections protrude radially away from the main body in opposite directions, and the first distribution channel distributes oil to a first rotor shaft coupled to a first electric motor and the second distribution channel distributes oil to a second rotor shaft coupled to a second electric motor. In a first example of the system, the main body further comprises a first outer rim and a second outer rim, the first and second outer rims positioned circumferentially about the main body. In a second example of the system, optionally including the first example, the first and second outer rims define therebetween a first groove and a second groove, wherein the first groove is in fluid communication with the first inlet section via a first inlet and the second groove is in fluid communication with the second inlet section via a second inlet, wherein the first and second inlets are arranged at opposite ends of the main body. In a third example of the system, optionally including one or both of the first and second examples, the first distribution channel is configured to direct oil from the first groove to the first outlet via the first inlet section and the first outlet section and the second distribution channel is configured to direct oil from the second groove to the second outlet via the second inlet section and the second outlet section. In a fourth example of the system, optionally including one or more or each of the first through third examples, the first and second grooves are separated by a dividing wall of the main body. In a fifth example of the system, optionally including one or more or each of the first through fourth examples, the first groove is in fluid communication with a first oil inlet and the second groove is in fluid communication with a second oil inlet, wherein oil entering the oil distributor via the first oil inlet is conditioned for the first electric motor and oil entering the oil distributor via the second oil inlet is conditioned for the second electric motor. In a sixth example of the system, optionally including one or more or each of the first through fifth examples, the first and second outlet sections are positioned coaxial with each other and with a shared axis of rotation of the first and second rotor shafts. In a seventh example of the system, optionally including one or more or each of the first through sixth examples, the first and second inlet sections are parallel to each other and positioned at an angle respective to the shared axis of rotation, the first inlet section positioned towards a first end of the oil distributor and the second inlet section positioned towards a second end of the oil distributor.

The disclosure also provides support for an electric drive unit, comprising: a first electric motor and a second electric motor arranged in a back-to-back configuration, and a common oil distributor positioned between the first electric motor and the second electric motor, the common oil distributor comprising a first distribution channel configured to distribute oil to the first electric motor and a second distribution channel configured to distribute oil to the second electric motor, wherein the first distribution channel comprises a first inlet in fluid communication with a first outlet via a first inlet section and a first outlet section and the second distribution channel comprises a second inlet in fluid communication with a second outlet via a second inlet section and a second outlet section. In a first example of the system, the first and second inlets and first and second inlet sections are included in a main body of the common oil distributor. In a second example of the system, optionally including the first example, the common oil distributor further comprises a first outer rim and a second outer rim positioned circumferentially about a main body. In a third example of the system, optionally including one or both of the first and second examples, the first and second outer rims comprise o-ring seals configured to seal off a first channel and a second channel between the first and second outer rims when the common oil distributor is positioned within a housing. In a fourth example of the system, optionally including one or more or each of the first through third examples, the first and second channels are separated by a dividing wall of the main body, the first channel being in fluid communication with the first inlet and the second channel being in fluid communication with the second inlet. In a fifth example of the system, optionally including one or more or each of the first through fourth examples, the first channel is in fluid communication with a first oil inlet and the second channel is in fluid communication with a second oil inlet, wherein the first and second oil inlets are positioned radial to the common oil distributor. In a sixth example of the system, optionally including one or more or each of the first through fifth examples, the first electric motor comprises a first rotor shaft and the second electric motor comprises a second motor shaft, wherein the first and second rotor shafts share an axis of rotation and the first and second outlet sections of the common oil distributor are arranged coaxial with the axis of rotation. In a seventh example of the system, optionally including one or more or each of the first through sixth examples, the first distribution channel comprises a first bend between the first inlet section and the first outlet section and the second distribution channel comprises a second bend between the second inlet section and the second outlet section, wherein the first and second bends are positioned adjacent to one another.

The disclosure also provides support for an oil distribution system for an electric drive unit, comprising: an oil distributor positioned between a first rotor shaft coupled to a first electric motor and a second rotor shaft coupled to a second electric motor, wherein the first and second electric motors are arranged in a back-to-back configuration and the oil distributor is configured to: receive oil conditioned for the first electric motor from a first oil inlet, receive oil conditioned for the second electric motor from a second oil inlet, distribute oil from the first oil inlet to the first rotor shaft via a first distribution channel, and distribute oil from the second oil inlet to the second rotor shaft via a second distribution channel. In a first example of the system, the first and second distribution channels each comprise an inlet configured for receiving oil from a respective oil inlet and an outlet configured for distributing oil to a respective rotor shaft. In a second example of the system, optionally including the first example, the oil distributor further comprises a main body arranged perpendicular to a shared axis of rotation of the first and second rotor shafts, wherein the inlet of each of the first and second distribution channels configured as part of the main body. In a third example of the system, optionally including one or both of the first and second examples, the main body comprises a first outer rim and a second outer rim that define therebetween a first groove and a second groove, the first groove in fluid communication with the inlet of the first distribution channel and the first oil inlet and the second groove in fluid communication with the inlet of the second distribution channel and the second oil inlet.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An oil distributor, comprising:
a first distribution channel comprising a first inlet section and a first outlet section; and
a second distribution channel comprising a second inlet section and a second outlet section, wherein:
the first and second inlet sections are included in a main body and the first and second outlet sections protrude radially away from the main body in opposite directions; and
the first distribution channel distributes oil to a first rotor shaft coupled to a first electric motor and the second distribution channel distributes oil to a second rotor shaft coupled to a second electric motor.

2. The oil distributor of claim 1, wherein the main body further comprises a first outer rim and a second outer rim, the first and second outer rims positioned circumferentially about the main body.

3. The oil distributor of claim 2, wherein the first and second outer rims define therebetween a first groove and a second groove, wherein the first groove is in fluid communication with the first inlet section via a first inlet and the second groove is in fluid communication with the second inlet section via a second inlet, wherein the first and second inlets are arranged at opposite ends of the main body.

4. The oil distributor of claim 3, wherein the first distribution channel is configured to direct oil from the first groove to the first outlet via the first inlet section and the first outlet section and the second distribution channel is configured to direct oil from the second groove to the second outlet via the second inlet section and the second outlet section.

5. The oil distributor of claim 3, wherein the first and second grooves are separated by a dividing wall of the main body.

6. The oil distributor of claim 3, wherein the first groove is in fluid communication with a first oil inlet and the second groove is in fluid communication with a second oil inlet, wherein oil entering the oil distributor via the first oil inlet is conditioned for the first electric motor and oil entering the oil distributor via the second oil inlet is conditioned for the second electric motor.

7. The oil distributor of claim 1, wherein the first and second outlet sections are positioned coaxial with each other and with a shared axis of rotation of the first and second rotor shafts.

8. The oil distributor of claim 7, wherein the first and second inlet sections are parallel to each other and positioned at an angle respective to the shared axis of rotation, the first inlet section positioned towards a first end of the oil distributor and the second inlet section positioned towards a second end of the oil distributor.

9. An electric drive unit, comprising:
a first electric motor and a second electric motor arranged in a back-to-back configuration; and
a common oil distributor positioned between the first electric motor and the second electric motor, the common oil distributor comprising a first distribution channel configured to distribute oil to the first electric motor and a second distribution channel configured to distribute oil to the second electric motor, wherein the first distribution channel comprises a first inlet in fluid communication with a first outlet via a first inlet section and a first outlet section and the second distribution channel comprises a second inlet in fluid communication with a second outlet via a second inlet section and a second outlet section.

10. The electric drive unit of claim 9, wherein the first and second inlets and first and second inlet sections are included in a main body of the common oil distributor.

11. The electric drive unit of claim 9, wherein the common oil distributor further comprises a first outer rim and a second outer rim positioned circumferentially about a main body.

12. The electric drive unit of claim 11, wherein the first and second outer rims comprise o-ring seals configured to seal off a first channel and a second channel between the first and second outer rims when the common oil distributor is positioned within a housing.

13. The electric drive unit of claim 12, wherein the first and second channels are separated by a dividing wall of the main body, the first channel being in fluid communication with the first inlet and the second channel being in fluid communication with the second inlet.

14. The electric drive unit of claim 12, wherein the first channel is in fluid communication with a first oil inlet and the second channel is in fluid communication with a second oil inlet, wherein the first and second oil inlets are positioned radial to the common oil distributor.

15. The electric drive unit of claim 9, wherein the first electric motor comprises a first rotor shaft and the second electric motor comprises a second motor shaft, wherein the first and second rotor shafts share an axis of rotation and the first and second outlet sections of the common oil distributor are arranged coaxial with the axis of rotation.

16. The electric drive unit of claim 9, wherein the first distribution channel comprises a first bend between the first inlet section and the first outlet section and the second distribution channel comprises a second bend between the second inlet section and the second outlet section, wherein the first and second bends are positioned adjacent to one another.

17. An oil distribution system for an electric drive unit, comprising:
an oil distributor positioned between a first rotor shaft coupled to a first electric motor and a second rotor shaft coupled to a second electric motor, wherein the first and second electric motors are arranged in a back-to-back configuration and the oil distributor is configured to:
receive oil conditioned for the first electric motor from a first oil inlet;
receive oil conditioned for the second electric motor from a second oil inlet;
distribute oil from the first oil inlet to the first rotor shaft via a first distribution channel; and
distribute oil from the second oil inlet to the second rotor shaft via a second distribution channel.

18. The oil distribution system of claim 17, wherein the first and second distribution channels each comprise an inlet configured for receiving oil from a respective oil inlet and an outlet configured for distributing oil to a respective rotor shaft.

19. The oil distribution system of claim 18, wherein the oil distributor further comprises a main body arranged perpendicular to a shared axis of rotation of the first and second rotor shafts, wherein the inlet of each of the first and second distribution channels configured as part of the main body.

20. The oil distribution system of claim 19, wherein the main body comprises a first outer rim and a second outer rim that define therebetween a first groove and a second groove, the first groove in fluid communication with the inlet of the first distribution channel and the first oil inlet and the second groove in fluid communication with the inlet of the second distribution channel and the second oil inlet.
